(19) United States
(12) Patent Application Publication
(10) Pub. No.: US 2007/0120025 A1
(43) Pub. Date: May 31, 2007

(54) Structural beam clamp with cast body

(76) Inventors: Eric J. Wilson, Solon, OH (US); Daniel S. Mominee, Chandler, AZ (US); Michael H.-S. Oh, Twinsburg, OH (US); Raymond S. Laughlin, Middlefield, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/598,862

(22) Filed: Nov. 14, 2006

Related U.S. Application Data
(60) Provisional application No. 60/736,363, filed on Nov. 14, 2005.
(60) Provisional application No. 60/749,227, filed on Dec. 9, 2005.

(51) Int. Cl. F16M 11/00

(52) U.S. Cl. 248/125.7

(57) ABSTRACT

A structural clamp has a cast body with an open back portion or slot for receiving, in a hollow in the body, a threaded rod or bar to which the clamp is to be coupled. The body has one or more protrusions on at least one of the top and bottom surfaces of the body, to engage a first threaded fastener, which is threaded on the threaded rod. The protrusions operate to keep the first threaded fastener in place while a second threaded fastener is tightened against the opposite side of the body. In an alternative configuration, the structural clamp with the open slot or back end may have a threaded fastener secured in a recess or hollow in the clamp body by a clip that is snapped onto the clamp body. The clip may also aid in securing the threaded rod within a hollow in the clamp body.

### REFERENCE TO RELATED APPLICATION

This application claims priority under 35 USC 119 to U.S. Provisional Patent Application No. 60/736,363, filed Nov. 14, 2005, and to U.S. Provisional Patent Application No. 60/749,227, filed Dec. 9, 2005. Both of the foregoing applications are hereby incorporated in their entireties.

### BACKGROUND OF THE INVENTION

1. Technical Field of the Invention

This invention relates generally to heavy duty structural clamps, and more particularly to clamps using primarily threaded rod for fixing and hanging a variety of items such as pipe, lighting and heating fixtures, duct work, cables or cable trays from a variety of structural members such as beams, struts, Z-purlins, T-bars, or other structural shapes.

2. Description of the Related Art

Heavy duty clamps such as beam clamps are often used as hangers and have a notch or jaw opening receiving an edge of a structure flange such as a beam. The upper part of the jaw is provided with a clamping bolt or set screw directed to the lower or bottom jaw. A flange fits in the jaw and as the clamping bolt or screw is tightened against the top of the flange the clamp is secured to the flange of the structure. An object supported by the clamp is often supported by a threaded rod which may extend through a nut or thread form in the body of the clamp clear of the edge of the flange. However some clamps secure the rod to a thread form in the bottom of the jaw in alignment with the clamping bolt. Other items are hung or supported with intermediate fixtures to support wiring, conduit, swivel connections or even struts.

Due to the continuing popularity of such clamps, it will be appreciated that it would be desirable to have improvements in such clamps, such as in ease or flexibility of use, reduced cost, reduced weight, increased performance, and/or with regard to other factors.

### SUMMARY OF THE INVENTION

According to an aspect of the invention, a structural clamp has a body with an open back portion for receiving a threaded bar or rod to which the clamp is to be coupled. According to one embodiment, the clamp body is secured to the threaded rod by threaded fasteners that bear on top and bottom surfaces of the clamp body. The top and bottom surfaces may have protrusions to lock one or both of the threaded fasteners in place.

According to another embodiment, the threaded rod is secured within the clamp body by a clip that is mechanically coupled to the clamp body. The clip may secure the fastener within the clamp body, either in a central hollow within the body, or in a recess in the top or bottom surface of the clamp body. The clip may be configured to secure the fastener within a pocket within a hollow in the clamp body.

According to another aspect of the invention, a structural clamp includes a clamp body having a main body portion, and top and bottom flanges protruding from the main body portion. The clamp body has a hollow portion running therethrough, accessible through an open slot in the clamp body.

According to yet another aspect of the invention, a structural clamp includes: a cast clamp body having a main body portion, and top and bottom flanges protruding from the main body portion. The clamp body has a hollow portion running therethrough.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the accompanying drawings, which are not necessarily to scale:

FIG. 1 is an oblique view showing the front, side, and top of a first embodiment clamp in accordance with the present invention;

FIG. 2 is a back view of the clamp of FIG. 1;

FIG. 3 is a side view of the clamp of FIG. 1;

FIG. 4 is an oblique view showing the front, side, and bottom of the clamp of FIG. 1;

FIG. 5 is a partially exploded view of the clamp of FIG. 1;

FIG. 6 is an oblique view showing the back, side, and bottom of a first alternate configuration of the clamp of FIG. 1;

FIG. 7 is a front view of the first alternate configuration;

FIG. 8 is an oblique view showing the front, side, and bottom of a second alternate configuration of the clamp of FIG. 1;

FIG. 9 is an oblique view showing the front, side, and top of a second embodiment clamp in accordance with the present invention;

FIG. 10 is an oblique view showing the front, side, and bottom of the clamp of FIG. 9, with the second fastener loosened;

FIG. 11 is a back view of the clamp of FIG. 9;

FIG. 12 is a plan view of the clamp of FIG. 9;

FIG. 13 is an oblique view showing the front, side, and top of a third embodiment clamp in accordance with the present invention;

FIG. 14 is an oblique view showing the front, side, and bottom of the clamp of FIG. 13;

FIG. 15 is an oblique view showing the front, side, and top of a fourth embodiment clamp in accordance with the present invention;

FIG. 16 is an oblique view showing the back, side, and bottom of the clamp of FIG. 15;

FIG. 17 is an exploded oblique view of the clamp of FIG. 15;

FIG. 18 is a plan view of a clip that is part of the clamp of FIG. 15;

FIG. 19 is an oblique view of an alternative configuration of the clamp of FIG. 15, utilizing an alternative clip;

FIG. 20 is an exploded oblique view of the configuration of FIG. 19;

FIG. 21 is a plan view of the alternative clip of the configuration of FIG. 19;

FIG. 22 is an oblique view of another alternative configuration of the clamp of FIG. 15, utilizing another alternative clip;

FIG. 23 is an exploded oblique view of the configuration of FIG. 22;

FIG. 24 is a plan view of the another alternative clip of the configuration of FIG. 22;

FIG. 25 is an oblique view of a fifth embodiment clamp in accordance with the present invention;

FIG. 26 is an exploded oblique view of the clamp of FIG. 25;

FIG. 27 is a plan view of a clip that is part of the clamp of FIG. 25;

FIG. 28 is an oblique view of an alternative configuration of the clamp of FIG. 25, utilizing an alternative clip;

FIG. 29 is an exploded oblique view of the configuration of FIG. 28;

FIG. 30 is a plan view of the alternative clip of the configuration of FIG. 28;

FIG. 31 is an oblique view showing the front, side, and top of a sixth embodiment clamp in accordance with the present invention;

FIG. 32 is an oblique view showing the back, side, and top of the clamp of FIG. 31;

FIG. 33 is an exploded oblique view of the clamp of FIG. 31;

FIG. 34 is a side exploded view of the clamp of FIG. 31;

FIG. 35 is a plan view of a clip that is part of the clamp of FIG. 31;

FIG. 36 is an oblique view showing the front, side, and top of an alternative configuration of the clamp of FIG. 31, utilizing an alternative clip;

FIG. 37 is an oblique view showing the back, side, and top of the configuration of FIG. 36; and

FIG. 38 is an exploded oblique view of the configuration of FIG. 36.

### DETAILED DESCRIPTION

A structural clamp has a body with an open back portion or slot for receiving, in a hollow in the body, a threaded rod or bar to which the clamp is to be coupled. The body has one or more protrusions on at least one of the top and bottom surfaces of the body, to engage a first threaded fastener, such as a square nut or hex nut, which is threaded on the threaded rod. The protrusions operate to keep the first threaded fastener in place while a second threaded fastener is tightened against the opposite side of the body. The second fastener may be used in conjunction with a flanged washer, lock washer, or other such auxiliary piece to aid in maintaining the body of the clamp locked in place on the threaded rod. The protrusions act against at least one of the fasteners to prevent the threaded rod from being disengaged from the hollow in the body. The body has a top flange with a threaded hole, and a bottom flange. A clamp screw may be threadedly engaged through the threaded hole in the top flange to bear against a clamped object located between the top and bottom flanges, thereby securely holding the object to the structural clamp. The clamp body may be made by casting.

The structural clamp advantageously allows securing of the clamp body to the threaded rod without the need to pass the rod through any hole in the body of the clamp. The fasteners may be pre-positioned on the threaded rod, with the clamp body later attached after installation of the rod to a pipe or other fixture to which the threaded rod will support. The clamp body is placed on the threaded rod between the fasteners, using the open back portion or slot of the body to place the clamp body around the threaded rod, with the rod in the hollow of the body. The body is then pressed against one of the fasteners, which is prevented from rotating by one or more protrusions on the body, while the other fastener is tightened against the body.

In an alternative configuration, the structural clamp with the open slot or back end may have a threaded fastener secured in a recess or hollow in the clamp body by a clip that is snapped onto the clamp body. The clip may also aid in securing the threaded rod within a hollow in the clamp body.

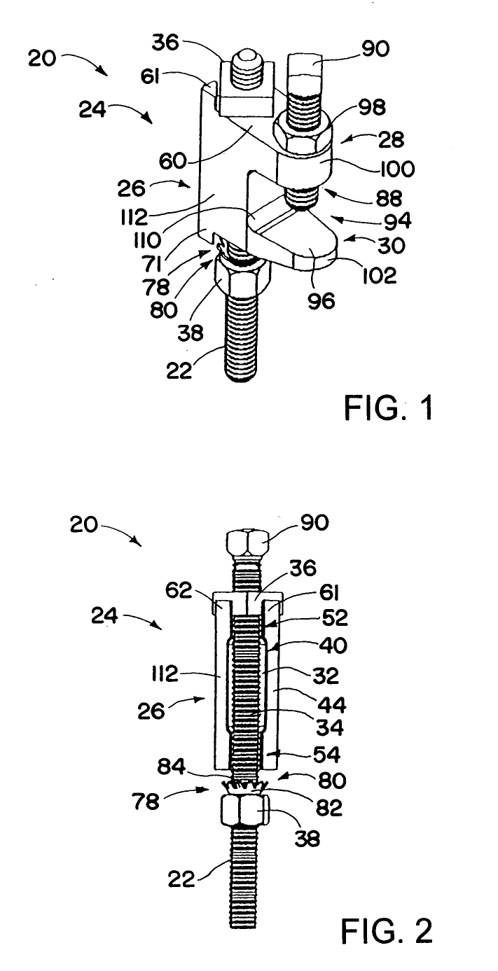

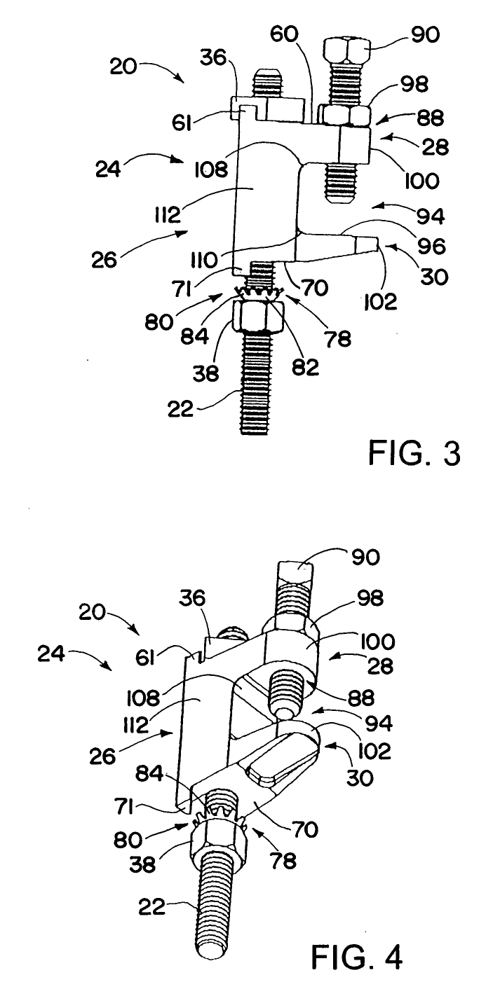

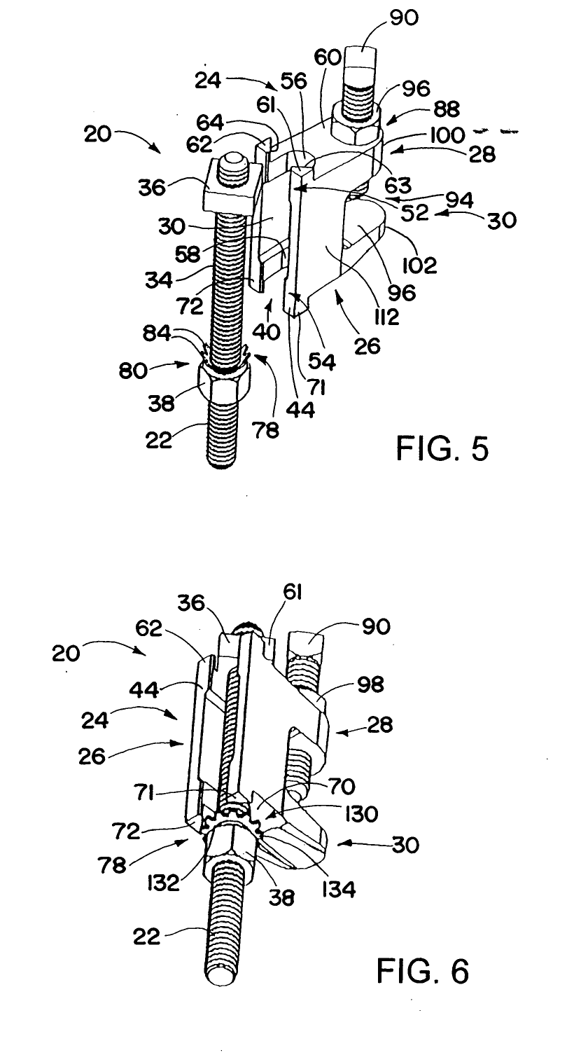

Referring initially to FIGS. 1-5, a clamp 20 is used for securing objects to a threaded rod or bar 22. The clamp 20 has a clamp body 24 with a main body portion 26 having a top flange 28 and a bottom flange or platform 30 extending therefrom. The clamp body 24 may be cast from a suitable metal, such as a suitable iron or steel.

The main body portion 26 has a hollow 32 therein for receiving a portion 34 of the threaded rod 22 between a first fastener 36 and a second fastener 38. In the illustrated embodiment the first fastener 36 is a square nut and the second fastener 38 is a hex nut, although it will be appreciated that other suitable sorts of fasteners may be employed, some of which are described below with regard to other embodiments. As will be described in greater detail later, the fasteners 36 and 38 are tightened against the main body portion 26 to secure the clamp body 24 to the threaded rod 22. In general terms, the first fastener 36 is secured by engagement with the main body portion 26 and the second fastener 38 acts as a locknut to tighten both of the fasteners 36 and 38 against the main body portion 26.

The hollow 32 may accessed by an open back or slot 40 in a back surface 44 of the clamp body 24. This allows the clamp body 24 to be placed on the threaded rod 22 after connection of the threaded rod 22 to a fixture or other equipment, without a need to thread the clamp body 24 over an end of the threaded rod 22. The fasteners 36 and 38 may be pre-threaded onto the threaded rod 22 before connection of the threaded rod 22 to the fixture or other equipment, perhaps placed at locations where clamps 20 are to be located to secure the threaded rod 22 to a beam or other structure. Later, even after installation of the threaded rod 22, the clamp body 24 may be placed on the threaded rod 22, with a portion of the threaded rod 22 passing through the open back or slot 40 and into the hollow 32.

The hollow 32 may have a relatively wide central hollow portion 50, with a narrowed top guide portion 52 and a narrowed bottom guide portion 54. The guide portions 52 and 54 may have respective half-cylinder inner surfaces 56 and 58 that may have substantially the same radius as the threaded rod 22, so that the threaded rod 22 may be secured to the clamp body 24 without relative shifting or rattling between the threaded rod 22 and the clamp body 24. The central hollow portion 50 may be hollowed out to a greater extent, for example to save weight.

A top surface 60 of the main body portion 26 has a pair of protrusions 61 and 62 extending upward therefrom. The illustrated protrusions 61 and 62 are triangular in shape, and are configured to secure the square nut 36 to prevent rotation of the square nut 36 when the square nut is against the top surface. Thus the inner faces 63 and 64 of the protrusions 61 and 62 may be oriented at approximately right angles to one another. It will be appreciated that the protrusions 61 and 62 may have other suitable shapes, suitable for securing a square nut or a fastener having a different shape. Also, there may be a greater or lesser number of protrusions provided on the top surface 60 to secure the fastener 36. For instance, the protrusions 61 and 62 bear against two faces of the square nut 36. Additional protrusions may be provided at suitable locations to bear against the other faces of the square nut 36. Or it may be possible to prevent rotation of the square nut 36 with only a single protrusion.

A bottom surface 70 of the main body portion 26 also has a pair of protrusions 71 and 72 extending therefrom. The protrusions 71 and 72 may be identical to the protrusions 61 and 62 on the top surface 60. Having identical (or substantially identical) protrusions on both the top surface 60 and the bottom surface 70 allows flexibility in use of the clamp 20. For instance, the clamp body 24 may be inverted from the illustrated embodiment, with rotation of the square nut 36 prevented by engagement with the protrusions 71 and 72 when the square nut 36 is pressed up against the bottom surface 70 (which, because of the inversion of the clamp body 24, has now become an upper surface). As another alternative, the protrusions 71 and 72 allow the positions of the fasteners 36 and 38 to be switched, with the square nut 36 placed below the clamp body 24 and the hex nut 38 placed above the clamp body 24.

In addition to allowing flexibility in placement of the clamp 20, the protrusions 71 and 72 may aid in keeping the clamp 20 secured to the threaded rod 22. The protrusions 71 and 72 may serve to restrain the hex nut 38 from pulling out and away from the clamp body 24. Although the bearing of the protrusions 61 and 62 on the faces of the square nut 36 may be sufficient to keep the clamp 20 secured to the threaded rod 22, interaction of the protrusions 71 and 72 with the hex nut 38 may provide an additional measure of securement.

The protrusions 61, 62, 71, and 72 may be located relative to the guide portions 52 and 54 of the hollow 32 such that the threaded rod 22 is touching, or close to touching, the surfaces 56 and 58 when the protrusions 61 and 62 engage faces of the square nut 36. The result is a secure connection between the clamp 20 and the threaded rod 22.

The clamp 20 may have an additional fastener component 78 between the hex locknut 38 and the bottom surface 70 of the main body portion 26. The additional component 78 may function to aid in locking the hex locknut 38 in place by resiliently deforming and exerting a force, in a direction along the axis of the threaded rod 22, against both the hex locknut 38 and the main body portion 26. This keeps the hex nut 38 pressed against threads of the threaded rod 22, and thereby prevents the hex nut 38 from loosening over time. In addition, the additional fastener component 78 may engage the protrusions 71 and 72 to aid in keeping the clamp 20 secured to the threaded rod 22.

The additional fastener component 78 may also serve as a spacer, maintaining clearance between the bottom surface 70 and the second fastener 38. In installation of the clamp 20, the second fastener 38 must be free to rotate until the clamp body 24 is secured between the first fastener 36 and the second fastener 38. One way to accomplish this is by configuring the protrusions 71 and 72 so that the protrusions 71 and 72 do not interfere with rotation of the second fastener 38. This configuring is of course done in conjunction with selection of a fastener type (hex nut, square nut, etc.) for use as the second fastener 38. An alternative is to have the additional fastener component 78 be at least as thick as the height of the protrusions 71 and 72. This prevents any interference with the rotation of the second fastener 38 that the protrusions 71 and 72 might otherwise make. With an additional fastener component that provides sufficient spacing to clear the protrusions 71 and 72, the second fastener 38 may be selected from a wider range of fasteners, and may indeed be of the same type as the first fastener 36 (e.g., both fasteners may be square nuts).

A wide variety of suitable additional fastener components 78 may be used to accomplish one or more of the above functions. Only some of the wide variety of possible additional fastener components are described herein. It will be appreciated that multiple additional fastener components (e.g., a pair of stacked washers) may be used in a single installation. Alternatively, the additional fastener component 78 may be omitted entirely, if desired.

In the embodiment illustrated in FIGS. 1-5, the additional fastener component 78 is an external toothed lock washer 80 having a deformable bowed central section 82 ringed on the outside by teeth 84. The central section 82 is resiliently compressed as the hex nut 38 is tightened toward the bottom surface 70, thereby causing the central section 82 to apply a force against the hex nut 38 that keeps the hex nut 38 from loosening. The external teeth 84 of the lock washer 80 may engage the protrusions 71 and 72.

The top flange 28 has a central threaded hole 88 for receiving a clamp screw 90. The clamp screw 90 engages the threaded hole 88, directed toward a flat upper surface 96 of the bottom flange 30. The clamp screw 90 is used to secure a structural member, such as a beam flange, in a jaw opening 94 between the top flange 28 and the bottom flange upper surface 96. A clamp screw locknut 98 may be used to aid in locking the clamp screw 90 in place.

The bottom flange 30 protrudes further from the main body portion 26 than does the top flange 28. The top flange 28 has a rounded distal end 100, and the bottom flange 30 has a rounded distal end 102. Respective rounded shoulders 108 and 110 are present at the transition between the flanges 28 and 30, and a middle part 112 of the main body portion 26. The bottom flange 30 may have a hollowed-out portion 116 on its underside, with extraneous material omitted in order to save weight.

To secure the clamp 20 to the threaded rod 22, first the fasteners 36 and 38 are threaded on the rod 22 at opposite sides of the portion 34 of the threaded rod 22 upon which the clamp 20 is to be secured. Then the threaded rod 22 is inserted into the hollow 32 in the main body portion 26 of the clamp body 24, with the rod 22 passing through the open end or slot 40 in the back surface 44 of the clamp body 24. This may be done by movement of the threaded rod 22, such as with placement of the threaded rod 22 into engagement with a clamp that is already mounted to a beam or other structure. Or engagement may be accomplished by movement of the clamp body 24, such as by engaging an unattached clamp body onto a stationary threaded rod.

After the threaded rod 22 is in the hollow 32, the clamp body 24 is moved along the threaded rod 22 until the top surface 60 of the clamp body 24 is pressed against the square nut 36, with the protrusions 61 and 62 bearing against faces of the square nut 36 to prevent rotation of the square nut 36. If necessary, orientation of the clamp body 24 or the square nut 36 may be adjusted to allow proper engagement of the protrusions 61 and 62 and the faces of the square nut 36.

Once the square nut 36 is secured by the protrusions 61 and 62, the hex locknut 38 is tightened to press the lock washer 80 against the bottom surface 70 of the clamp body 24. The compressed lock washer 80 provides a force against the tightened hex locknut 38 to keep the locknut 38 from loosening, thereby securing the clamp 20 to the threaded rod 22.

As discussed earlier, one advantage of the clamp 20 is that it does not have to be threaded along the threaded rod 22, reducing installation time and increasing flexibility. The increase of flexibility may occur in that the clamp 20 may be installed after the threaded rod 22 has been put in place. There also may be increased flexibility regarding the order in which the clamps 20 are secured to the threaded rod 22. As long as the fasteners 36 and 38 are pre-threaded onto the threaded rod 22 at an appropriate location, additional of the clamps 20 may be secured anywhere along an already-secured threaded rod, even between already-installed clamps.

The clamp 20 may be secured to structural members, such as the flange of a beam or other structure member. The threaded rod 22 may be used for fixing and hanging a variety of items such as pipes, lighting and heating fixtures, duct work, cables or cable trays from a variety of structural members such as beams, struts, Z-purlins, T-bars, or other structural shapes.

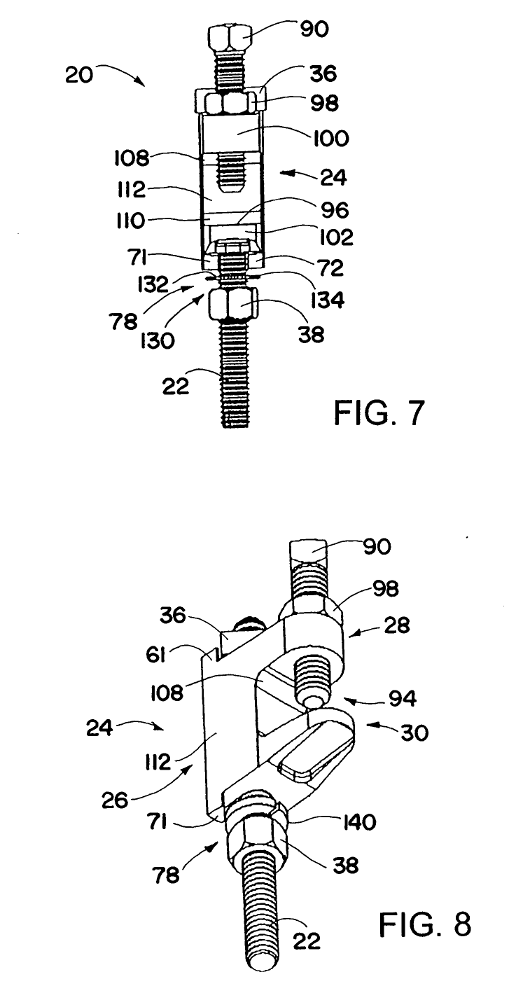

FIGS. 6 and 7 show an alternative configuration of the clamp 20, in which the additional fastener component 78 is a flat toothed washer 130 having a flat central portion 132 ringed by external teeth 134. The washer 130, unlike the bowed washer 80 (FIG. 1) does not provide a force against the hex locknut 38 to aid in preventing the hex locknut from loosening. Still, the flat washer 130 prevents direct contact between the hex locknut 38 and the bottom surface 70 of the clamp body 24, which might otherwise gouge the bottom surface 70. The teeth 134 may engage the protrusions 71 and 72 to prevent rotation of the washer 130 as the hex locknut 38 is tightened up against it.

FIG. 8 shows another alternative configuration of the clamp 20, in which the additional fastener component 78 is a split lock washer 140. The lock washer 140 resiliently compresses as the hex locknut 38 is tightened against it, providing a force against the tightened hex locknut 38 that prevents loosening of the locknut 38. It will be appreciated that many varieties of other washers and spacers are alternatives to the various illustrated embodiments.

What follows now are various alternate embodiments of the invention. Many of the features of the alternate embodiment clamps described below may be similar to corresponding features of the clamp 20. Discussion of these similar features is abbreviated or omitted in the below description of the alternate embodiment clamps, although it will be understood that the alternate embodiment clamps may include other features corresponding to those of the clamp 20. In addition, it will be appreciated that various features from the various embodiments may be combinable with one another.

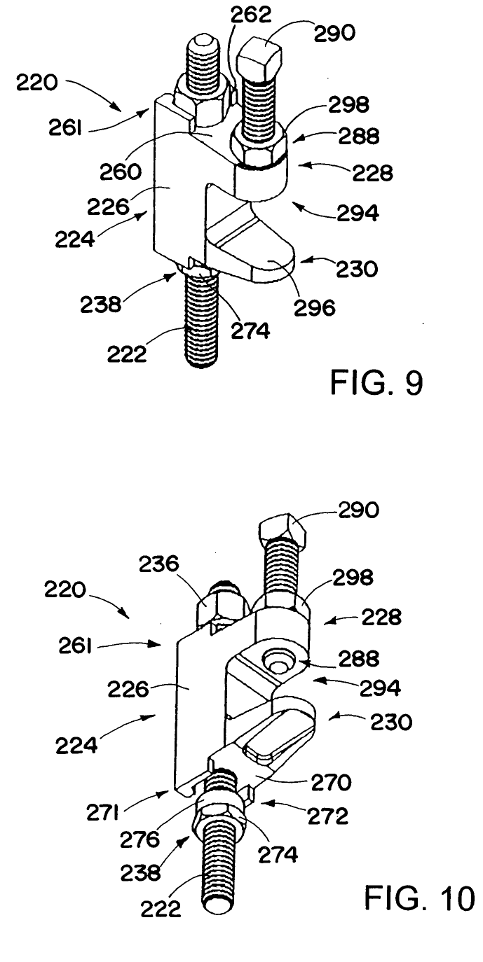

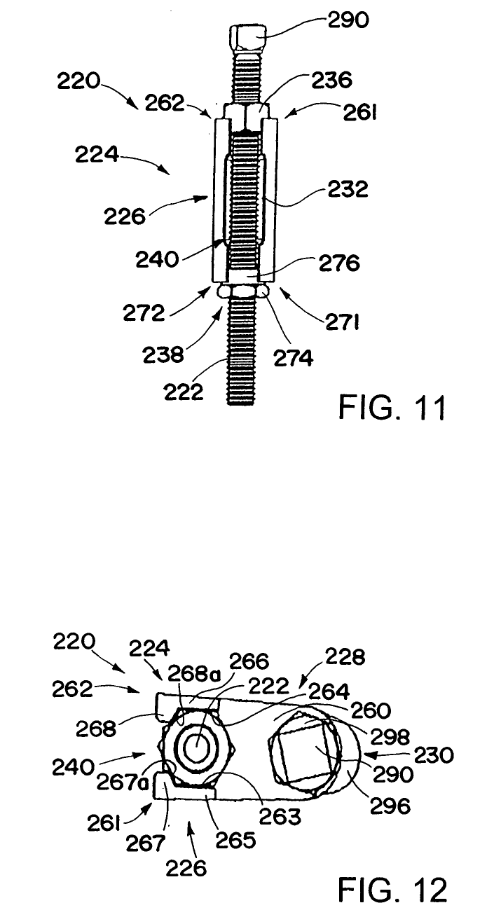

FIGS. 9-12 show an alternate embodiment, a clamp 220 with protrusions configured to engage a hex nut to prevent rotation of the hex nut while the clamp 220 is being secured to a threaded rod 222. The clamp 220 has a clamp body 224, which may be formed by casting, that has a main body portion 226, with a hollow 232 therein accessed by an open back portion or slot 240. The clamp body 224 has a top flange 228 and a bottom flange 230 defining a jaw opening 294 therebetween. The top flange 228 has a threaded hole 288 for receiving a clamp screw 290 for clamping objects in the jaw opening 294, between the clamp screw 290 and an upper surface or platform 296 of the bottom flange 230. A clamp screw locknut 298 may be used to lock the clamp screw 290 in place.

The clamp body 224 has protrusions 261 and 262 on an upper surface 260 of the main body portion 226. The protrusions 261 and 262 are configured to engage faces of a hex nut 236 employed as a first fastener, to prevent rotation of the hex nut 236 when it is engaged with the protrusions 261 and 262. The protrusions 261 and 262 have respective elongate bar portions 265 and 266 and respective angled projections 267 and 268 extending inward from the bar portions 265 and 266 toward a symmetry plane of the clamp body 224. The elongate bar portions 265 and 266 have respective inner faces 263 and 264 that are substantially parallel to one another, and spaced so as to engage a pair of diametrically-opposed faces of the hex nut 236. The inner faces 263 and 264 may each have an extent at least as long as a corresponding face of the hex nut 236. Thus the inner faces 263 and 264 may each engage substantially all of different faces of the hex nut 236. The angled projections 267 and 268 are configured to engage an additional pair of adjacent faces of the hex nut 236, with respective inner faces 267a and 268a angled at approximately 120° to one another. Thus together the protrusions 261 and 262 are configured to engage four faces of the hex nut 236, so as to prevent the hex nut 236 from rotating when the top surface 260 of the clamp body 224 is pressed up against the hex nut 236.

It will be appreciated that the configuration of the projections 261 and 262 shown in the figures and described above is only one possible specific configuration for the projections 261 and 262, and that other configurations for engaging the hex nut 236 are possible. To give one example, the angled projections 267 and 268 could be omitted entirely, relying on only the elongate bar portions 265 and 266 to prevent rotation of the hex nut 236.

Protrusions 271 and 272, substantially identical to the protrusions 261 and 262, are provided on a bottom surface 270 of the clamp body 224. A second fastener 238, a modified hex nut, is configured to press against the bottom surface 270, to secure the clamp 224 to the threaded rod 222. The second fastener 238 has hexagonal lower portion 274 and a round upper portion 276. The hexagonal lower portion 274 may have substantially the same size as the hex nut 236. The round upper portion 276 has a smaller diameter than the hexagonal lower portion 274, and has a thickness that may be at least as much as the height of the protrusions 271 and 272. The round upper portion 276 is configured to be able to rotate without engaging the protrusions 271 and 272. This allows the modified hex nut 238 to be threaded along the threaded rod 222 until it fully engages the bottom surface 270 of the clamp body 224. The round upper portion 276 may be fabricated by machining a portion of a hex nut that is substantially identical to the hex nut 236.

It will be appreciated that many variants are possible for the clamp 220. An additional fastener component, such as a suitable one of the additional fastener components 78 described above, may optionally be used in conjunction with the second fastener 238. With or without an additional fastener component, other configurations may be used for the second fastener 238.

The clamp 220 may be installed on the threaded rod 222 in a manner similar to that described above with regard to the clamp 20.

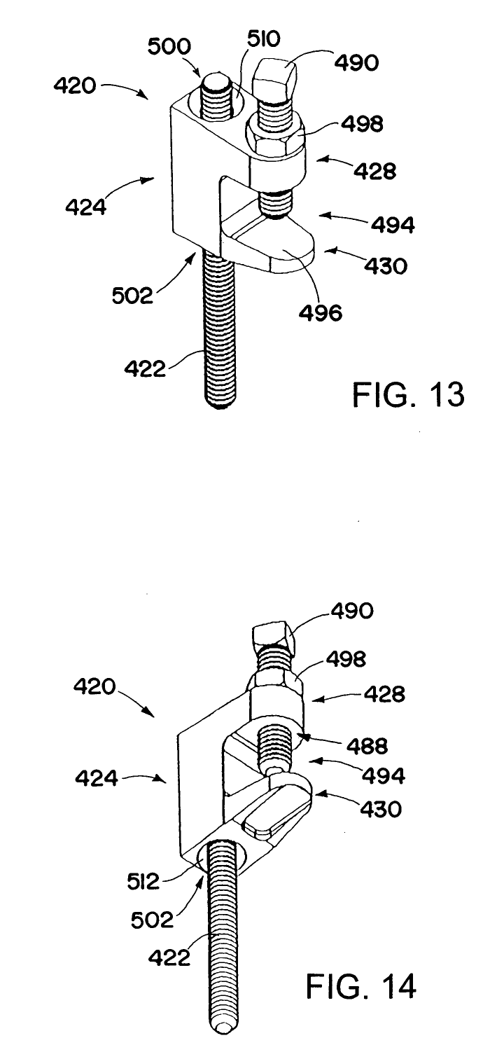

FIGS. 13 and 14 show another embodiment, a clamp 420 for engaging a threaded rod 422. Unlike the clamp 20 and clamp 220, the clamp 420 does not rely on fasteners, such as the fasteners 36, 38, 236, and 238, to hold it in place on the threaded rod 422. However, the clamp 420 is required to be threaded onto the threaded rod 422, which is another difference compared to the clamp 20 and the clamp 220.

The clamp 420 has a clamp body 424, which may be formed by casting, that has a main body portion 426, with a through hole 433 for receiving the threaded rod 422 therethrough, and for threadedly engaging a portion of the threaded rod 422. The clamp body 424 has a top flange 428 and a bottom flange 430 defining a jaw opening 494 therebetween. The engagement of the objects in the jaw opening 494 is similar to the engagement of objects in the jaw opening 94 and jaw opening 294. The top flange 428 has a threaded hole 488 for receiving a clamp screw 490 for clamping objects in the jaw opening 494, between the clamp screw 490 and an upper surface or platform 496 of the bottom flange 430. A clamp screw locknut 498 may be used to lock the clamp screw 496 in place.

The through hole 433 may have an enlarged central hollow within the main body portion 426, with a narrower top hole or passage 500 and a narrower bottom hole or passage 502 on opposite sides of the central hollow. One of the holes 500 and 502 is internally threaded to engage threads on the threaded rod 422, while the other of the holes 500 and 502 is smooth, to allow unhindered passage of the threaded rod 422 therethrough. The threaded hole may be either the top hole 500 or the bottom hole 502. Alternatively, both of the holes 500 and 502 may be threaded. As another alternative, the entire through hole 433 may have a substantially constant diameter throughout its length, with all or a portion internally threaded for engaging the threaded rod 422.

The clamp body 424 has a top surface 460 with a top chamfered shoulder 510 around the top hole 500. A bottom surface 470 of the clamp body 424 has a bottom chamfered shoulder 512 around the bottom hole 502. The chamfered shoulders 510 and 512 aid in guiding an end of the threaded rod 422 into the through hole 433 for the clamp body 424 to be threaded onto the threaded rod 422. Optionally, one or both of the chamfers 510 and 512 may be omitted.

The clamp body 424 may be made of malleable cast iron. The clamp body 424 may be electro zinc plated.

Alternatively, the clamp body 424 may be modified such that both of the holes 500 and 502 are smooth holes. In such a case one or more fasteners, such as nuts, may be used to secure the clamp 420 to a threaded rod.

What follows now are additional embodiments sharing a common concept that differs in some ways from that of the embodiments described above. The following embodiments utilize a cast body with an open back end, with a separate clip that engages the cast body. The clip is used to retain the threaded rod within the body.

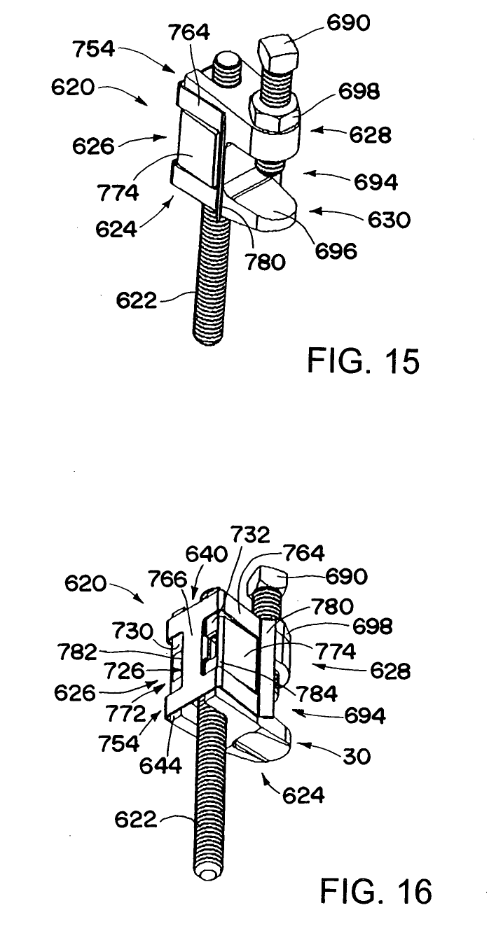

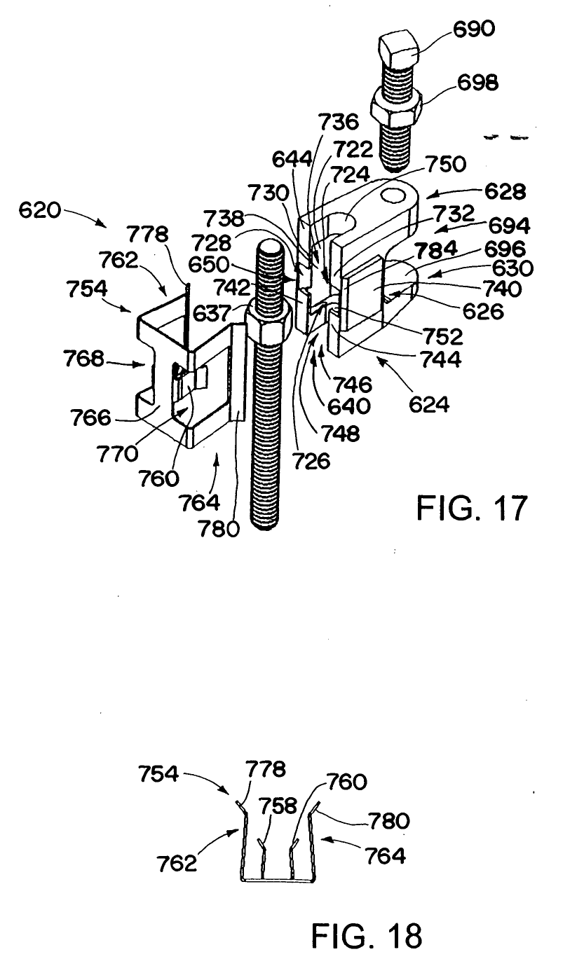

FIGS. 15-17 show a clamp 620 that has a clamp body 624 with an open back or slot 640 in a clamp body back surface 644 for receiving therein a threaded rod 622 therein. The clamp body 624 has a central main body portion 626 with a central hollow 650 therein for receiving both the threaded rod 622 and a fastener 637 coupled to the threaded rod 622. The fastener 637 may be a hex nut that is threaded onto the threaded rod 622.

The central hollow 650 is bordered by a pair of parallel walls 722 and 724 spaced so as to bear on and secure diametrically opposed faces of the fastener 637. The walls 722 and 724 prevent the fastener 637 from being turned when it is in the central hollow 650. A central hollow middle section 726 and a central slot portion 728 are open all the way, between the walls 722 and 724, along the clamp body back surface 644. The walls 722 and 744 may have chamfered back edges at the central hollow middle section 726, to urge the fastener 637 into the central hollow middle section 726. However, upper inward protrusions 732 and 734 protrude inward from upper sections of the walls 722 and 724, narrowing an upper slot portion 736 of the slot 640 in an upper section 738 of the central hollow 650. The upper slot portion 736 is wide enough to admit the threaded rod 622, but is not wide enough to allow the fastener 637 to pass through. Thus the upper hollow section 738 functions as an upper pocket that may be used to retain the fastener 637 within. The fastener 637 may be inserted into the middle hollow section 726 through the central slot portion 728, and then moved upward into the upper pocket 738. As long as the fastener 637 is in the upper pocket 738, it is unable to pass through the slot 640, and remains within the central hollow 650.

Similarly, a lower section 748 of the central hollow 650 is a lower pocket which can be used to retain the fastener 637 within. A lower slot portion 746 is too narrow to allow the fastener 637 to pass, due to the presence of lower protrusions 742 and 744 protruding inward into the slot 640 from back ends of the walls 722 and 724.

Above the upper pocket 738 is an upper cylindrical surface 750, and below the lower pocket 748 is a lower cylindrical surface 752. The cylindrical surfaces 750 and 752 may be used to bear against surfaces of the threaded rod 622. This may aid in supporting the threaded rod 622 and in keeping the threaded rod 622 from wobbling within the clamp body 624. The cylindrical surfaces 750 and 752 also block upward movement of the fastener 637 out of the upper pocket 738, and downward movement of the fastener 637 out of the lower pocket 748.

With reference now in addition to FIG. 18, a clip 754 is used to secure the threaded rod 622 and the fastener 637 within the clamp body 624. The clip 754 has a pair of inner gripping legs 758 and 760, and a pair of outer gripping legs 762 and 764. A central spine 766 couples together the inner legs 758 and 760, and the outer legs 762 and 764. The inner legs 758 and 760 fit into the central hollow middle section 726 when the clip 754 is installed on the clamp body 624. The inner legs 758 and 760 resiliently grip the threaded rod 622, aiding in preventing wobbling of the threaded rod 622. The inner legs 758 and 760 also block movement of the fastener 637 into the central hollow middle section 726 from the pockets 738 and 748.

The outer legs 762 and 764 resiliently grip side surfaces of the main body portion 626 of the clamp body 624. The outer legs 762 and 764 have respective windows or cutouts 768 and 770 therein shaped to receive respective protrusions 772 and 774 on side surfaces of the main body portion 626. The clip 754 is installed by pushing it onto the clamp body 624, toward the clamp body back surface 644. The outer legs 762 and 764 resiliently bend outward as the clip 754 is installed on the clamp body 624. Once the clip 754 is pushed in far enough, the outer legs 762 and 764 snap into place around the protrusions 772 and 774, with the protrusions 772 and 774 in the windows 768 and 770. This securely holds the clip 754 to the clamp body 624. The outer legs 762 and 764 have outturned front flanges 778 and 780. The protrusions 772 and 774 have chamfered back edges 782 and 784. The outturned flanges 778 and 780 and the chamfered back edges 782 and 784 facilitate bending the outer legs 762 and 764 out and around the protrusions 772 and 774 as the clip 754 is installed. To release the clip 754 from the clamp body 724, the outturned front flanges 778 and 780 may be pulled outwards until the outer legs 762 and 764 clear the protrusions 772 and 774. Then the clip 754 can be pulled off of the clamp body 624.

The clamp 620 may be secured to a beam flange or other structure in a manner similar to that of the other embodiments described above. That is, the clamp body 624 has a top flange 628 and a bottom flange 630 defining a jaw opening 694 therebetween. The top flange 628 has a threaded hole 688 for receiving a clamp screw 690 for clamping objects in the jaw opening 694, between the clamp screw 690 and an upper surface or platform 696 of the bottom flange 630. A clamp screw locknut 698 may be used to lock the clamp screw 696 in place.

In installation of the clamp 620 onto the threaded rod 622, first the threaded rod 622 and the fastener 637 are inserted into the slot 640. The fastener is inserted into the middle slot portion 728, which may be the only portion of the slot 640 that is wide enough for passage of the fastener 637. Then the clamp 620 and/or the threaded rod 622 are moved, so as to locate the fastener 637 in one of the pockets 738 or 748. Then the clip 754 is installed by pressing it onto the clamp body 624, securing the fastener 637 in one of the pockets 738 or 748. The threaded rod 622 is secured by the cylindrical surfaces 750 and 752 and by the inner legs 758 and 760. Thus the clamp 620 may be secured to threaded rod 622 even after the threaded rod 622 has been installed, even if other items have been coupled to the threaded rod 622 above and below the clamp 620.

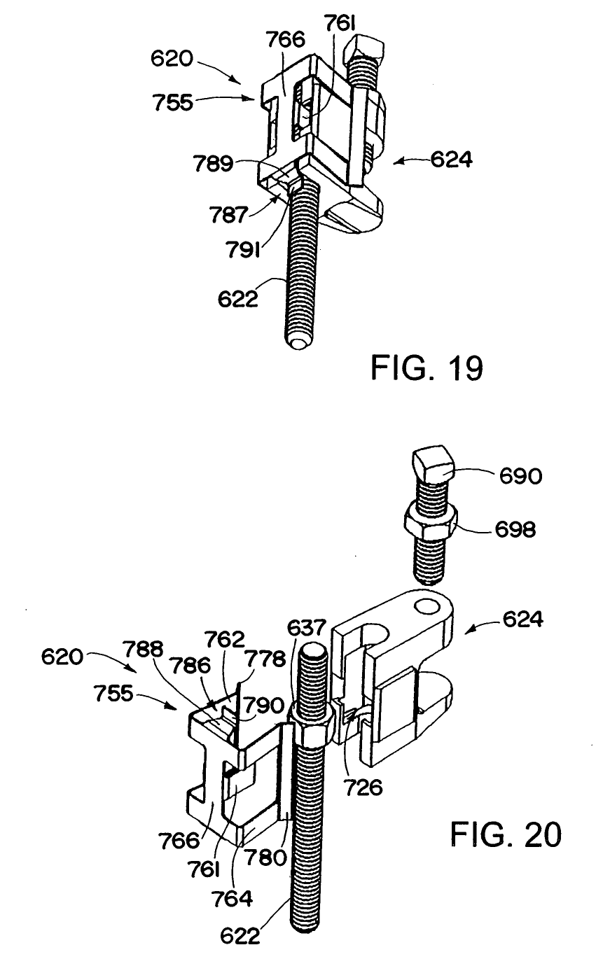

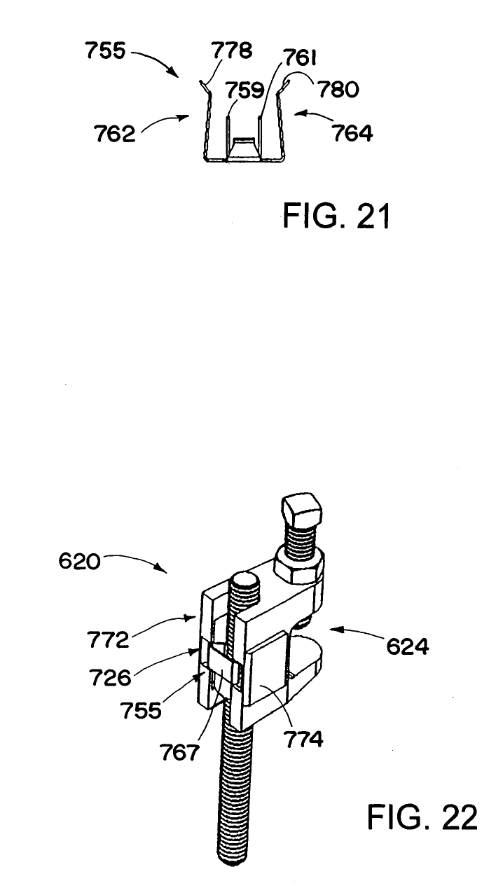

FIGS. 19-21 show a variation of the clamp 620 which utilizes a clip 755 having a somewhat different design from that of the clip 754 (FIG. 18). The clip 755 uses the same resilient outer legs 762 and 764 as the clip 754, which grip the protrusions 772 and 774 on the sides of the central body portion 626 of the clamp body 624. Inner legs 759 and 761 of the clip 755 do not resiliently grip the threaded rod 622, but rather are straight legs that protrude from the clip central spine 766 into the middle hollow section 726. The inner legs 759 and 761 keep the fastener 637 in the pockets 738 or 748.

The clip 755 includes a pair of L-shape or dogleg extensions 786 and 787 that protrude from the top and bottom of the clip central spine 766. The extensions 786 and 787 have respective legs 788 and 789 and rod-engaging tabs 790 and 791. The legs 788 and 789 are connected to opposite ends of the central spine 766, and are directed inward toward the threaded rod 622 when the clip 755 is installed. The tabs 790 and 791 are bent free ends of the extensions 786 and 787. The tabs 790 and 791 may be angled substantially at right angles or other suitable angles to the legs 788 and 789. The tabs 790 and 791 bear against the threaded rod 622 when the clip 755 is installed. The threaded rod 622 is secured top and bottom between respective of the tabs 790 and 791 and the cylindrical surfaces 750 and 752. This keeps the threaded rod 622 from wobbling.

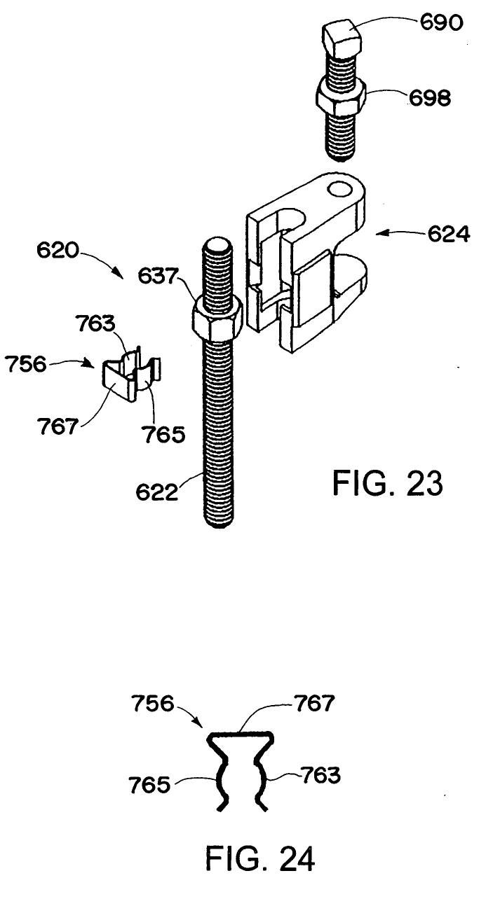

FIGS. 22-24 show another variant of the clamp 620, which utilizes a smaller clip 756. The clip 756 has a pair of resilient rod-gripping legs 763 and 765 emanating from a central clip body 767. The legs 763 and 765 may be similar to the inner legs 758 and 760 of the clip 764 (FIG. 18), being configured to be pressed onto and grip the threaded rod 622 within the middle hollow section 726. The legs 763 and 765 prevent entry of the fastener 637 into the middle hollow section 726. Although the clip 756 does not constrain movement of the threaded rod 622, it will be appreciated that the clip 756 is lighter and easier to manufacture than the clips 754 and 755. In addition, the clip 756 allows the clamp body protrusions 772 and 774 to be omitted.

The clamp body 624 (as with the other clamp bodies described herein), may be made by casting out of any of a variety of suitable materials, such as ductile iron. The clips 754, 755, and 756 may be made out of spring steel.

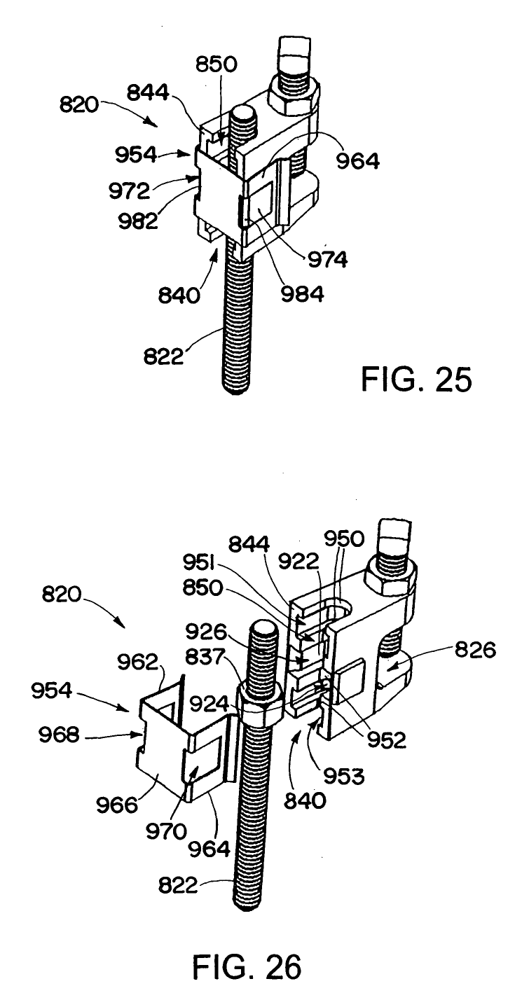

Turning now to FIGS. 25 and 26, a clamp 820 has a clamp body 824 that clamps to a beam flange or other structure. The clamp body 824 has an open slot 840 along a back surface 844. The open slot 840 is for receiving a threaded rod 822 and a fastener 837, such as a hex nut, that is threaded on the rod 822. The threaded rod 822 and the fastener 837 are received into a central hollow 850 of the clamp body 824. The fastener 837 fits into a middle central hollow 926, with faces of the fastener 837 secured between parallel walls 922 and 924 along opposite sides of the middle central hollow 926. The bearing of the parallel walls 922 and 924 on diametrically-opposed faces of the fastener 837 keeps the fastener 837 from rotating within the middle central hollow 926. Unlike the clamp 620 (FIGS. 15-17), the fastener 837 is retained in the middle central hollow 926 when the threaded rod 822 and the fastener 837 are secured within the clamp body 824. The clamp body 824 does not have anything corresponding to the pockets 738 and 748 of the clamp body 624 (FIGS. 15-17).

The clamp body 824 has upper cylindrical surfaces 950 and lower cylindrical surfaces 952 for engaging surfaces of the threaded rod 822. There may be respective upper and lower hollows 951 and 953 in the vicinity of the cylindrical surfaces 950 and 952, in which the hollows are expanded in order to reduce weight of the clamp body 824.

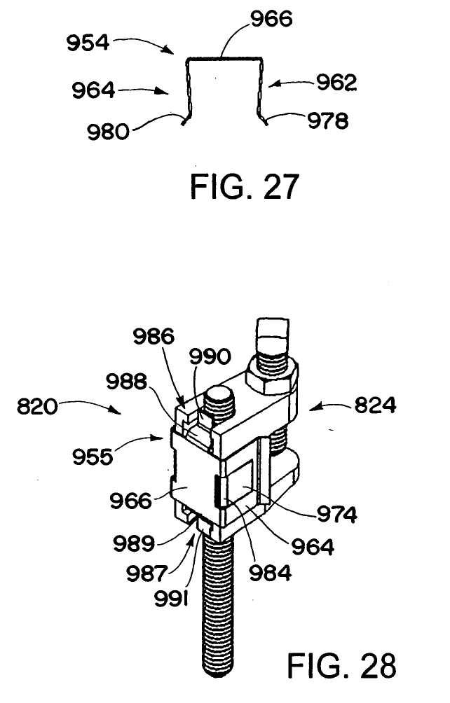

With reference now in addition to FIG. 27, a clip 954 is used to retain the threaded rod 822 and the fastener 837 in the central hollow 850. The clip 954 has a clip central body 966 and a pair of gripping legs 962 and 964 emanating from the clip central body 966. The central clip body 966 fits over a middle part of the clamp body back surface 844. Specifically, the clip central body 966 covers the middle central hollow 926 so that the fastener 837 is retained within the middle central hollow 826.

The gripping legs 962 and 964 may be substantially the same as the outer gripping legs 762 and 764 of the clip 754 (FIGS. 15-18). That is, the gripping legs 962 and 964 resiliently grip side surfaces of the main body portion 826 of the clamp body 824. The gripping legs 962 and 964 have respective windows or cutouts 968 and 970 for receiving protrusions 972 and 974 on side surfaces of the main body portion 826. The gripping legs 962 and 964 have outturned front flanges 978 and 980, and the protrusions 972 and 974 have chamfered back edges 982 and 984.

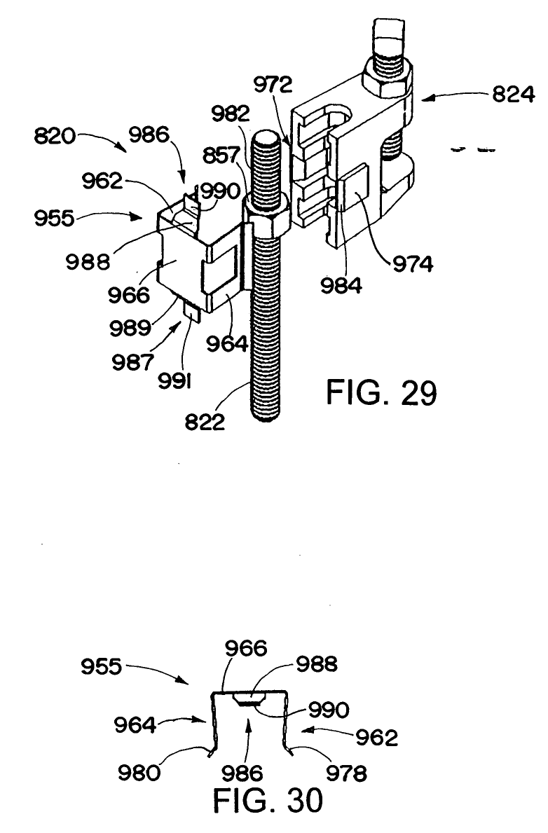

FIGS. 28-30 show a variation of the clamp 820 which utilizes a clip 955. The clip 955 uses the same resilient legs 962 and 964 as the clip 954 (FIGS. 25-27), which grip the protrusions 972 and 974 on the sides of the central body portion 826 of the clamp body 824. The clip 955 also includes a pair of L-shape or dogleg extensions 986 and 987 that protrude from the top and bottom of the clip central body 966. The extensions 986 and 987 may be similar to the extensions 786 and 787 of the clip 755 (FIGS. 19-21). The extensions 986 and 987 have respective legs 988 and 989 and rod-engaging tabs 990 and 991. The legs 988 and 989 are connected to opposite ends of the clip central body 966, and are directed inward toward the threaded rod 822 when the clip 955 is installed. The legs 988 and 989 have a trapezoidal shape, narrowing from a relatively wide end where the legs 988 and 989 are connected to the clip central body 966, to a relatively narrow end where the tabs 990 and 991 are connected to the legs 988 and 989. The tabs 990 and 991 are bent free ends of the extensions 986 and 987, and may suitably be angled to the legs 988 and 989. The tabs 990 and 991 bear against the threaded rod 822 when the clip 955 is installed. The threaded rod 822 is secured top and bottom between respective of the tabs 990 and 991 and the cylindrical surfaces 950 and 952.

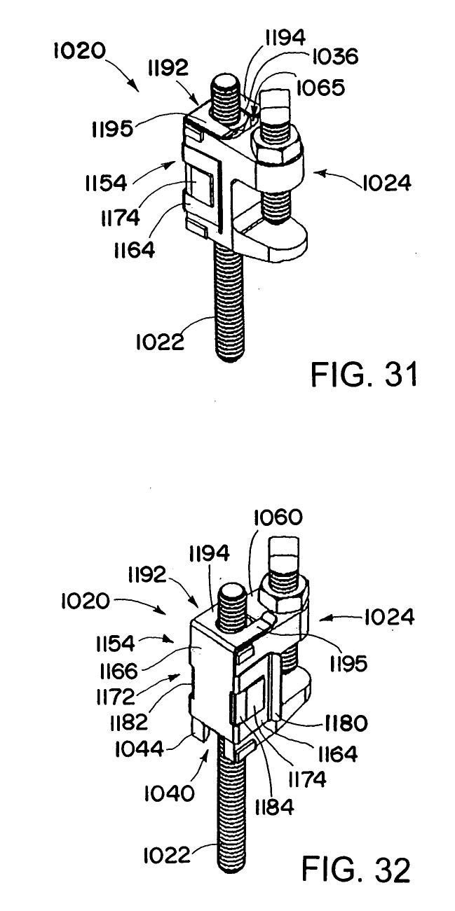

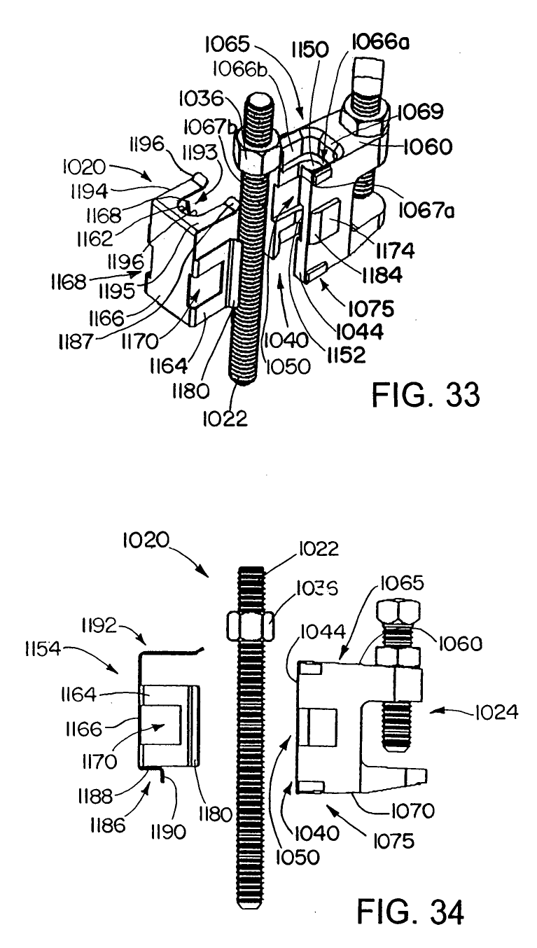

FIGS. 31-34 illustrate another embodiment, a clamp 1020. The clamp 1020 includes a clamp body 1024 that has an open slot 1040 along a clamp body back surface 1044. The open slot 1040 is configured for receiving a threaded rod 1022, and a fastener 1036 threaded onto the rod 1022. The fastener 1036 may be a hex nut or square nut. The clamp body 1024 has a central hollow 1050 for retaining the threaded rod 1022 therein. An upper cylindrical surface 1150 and a lower cylindrical surface 1152 are configured to engage and support the threaded rod 1022 when the threaded rod 1022 is in the hollow 1050.

The clamp body 1024 includes a top fastener-receiving recess 1065 in a top surface 1060 of the clamp body 1024. The recess 1065 may be have a pair of parallel walls 1066a and 1066b for engaging respective diametrically-opposed faces of the fastener 1036. The walls 1066a and 1066b prevent rotation of the fastener 1036 when the fastener 1036 is within the recess 1065. The recess 1065 may have a generally rectangular shape, with flanges 1067a and 1067b along the back surface 1044 to prevent the fastener 1036 from being pulled out the recess 1065 through the slot 1040. The recess 1065 may have a rounded or chamfered shoulder 1069 along the clamp body top surface 1060. The shoulder 1069 may facilitate placement of the fastener 1036 within the recess 1065, guiding the fastener 1036 into the recess 1065 as the threaded rod 1022 is pulled downward through the hollow 1050 of the clamp body 1024.

In installation of the clamp 1020, the threaded rod 1022 is passed through the slot 1040 into the hollow 1050, with the fastener 1036 above the clamp body 1024. The threaded rod 1022 is then pulled downward to bring the fastener 1036 into the recess 1065. This clamps the fastener 1036 between the walls 1066a and 1066b of the recess 1065, preventing rotation of the fastener relative to the clamp body 1024.

The clamp body 1024 may have a bottom fastener-receiving recess 1075 in a bottom surface 1070 of the clamp body 1024. The bottom recess 1075 may be substantially identical to the top recess 1065 in both shape and function. The placement of the recesses 1065 and 1075 on opposite ends of the clamp body 1024 advantageously allows the clamp body 1024 to be flipped over. Alternatively, the fastener 1036 may be secured at either side of the clamp body 1024.

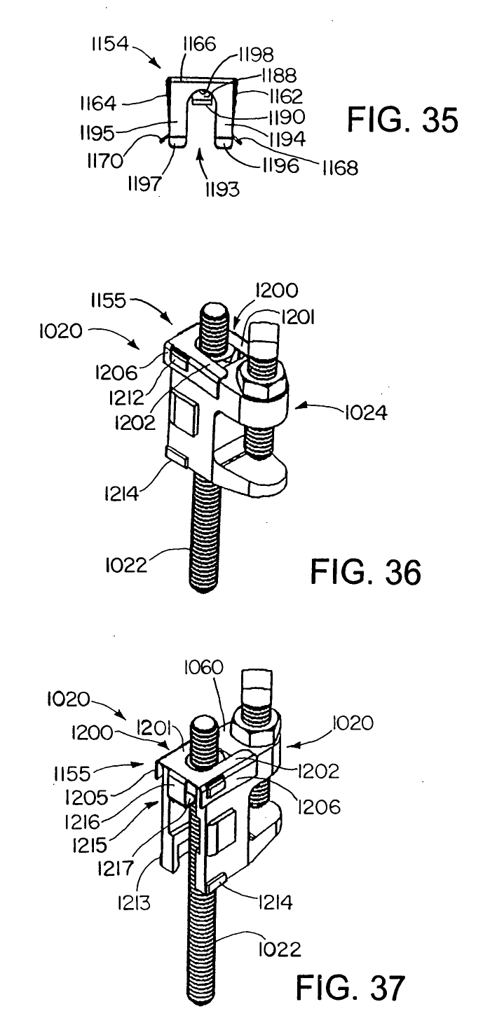

Referring now in addition to FIG. 35, a clip 1154 is used secure the threaded rod 1022 and the fastener 1036. The clip 1154 has a clip central body 1166 and a pair of gripping legs 1162 and 1164 emanating from the clip central body 1166. The clip central body 1166 fits over a middle part of the clamp body back surface 1044. The gripping legs 1162 and 1164 may be similar in configuration and function as the outer gripping legs 762 and 764 (FIGS. 15-18) and the gripping legs 962 and 964 (FIGS. 25-27). The gripping legs 1162 and 1164 resiliently grip side surfaces of a main body portion 1026 of the clamp body 1024. The gripping legs 1162 and 1164 have respective windows or cutouts 1168 and 1170 for receiving central protrusions 1172 and 1174 on side surfaces of the main body portion 1026. The gripping legs 1162 and 1164 have outturned front flanges 1178 and 1180. The central protrusions 1172 and 1174 have chamfered back edges 1182 and 1184.

The clip 1154 includes an L-shape or dogleg extension 1186 emanating or protruding from a bottom end of the clip central body 1166. The extension 1186 may be similar to the extensions 786 and 787 of the clip 755 (FIGS. 19-21). The extension 1186 has a leg 1188 and a rod-engaging tab 1190. The leg 1188 is bent inward from the bottom end of the clip central body 1166, directed inward toward the threaded rod 1022 when the clip 1154 is installed. The leg 1188 has a trapezoidal shape, similar to the legs 988 and 989 of the clip 955 (FIGS. 28-30). The tab 1190 is a bent free end of the extension 1186. The tab 1190 bears against the threaded rod 1022 when the clip 1154 is installed.

The clip 1154 also has a top fastener-retaining flange 1192 for retaining the fastener 1036 within the recess 1065. The flange 1192 is bent inward from a top end of the clip central body 1166, in the same general direction as the gripping legs 1162 and 1164. The flange 1192 has a U-shape notch 1193 in its distal end, with flange legs 1194 and 1195 passing around either side of the threaded rod 1022. The flange legs 1194 and 1195 have respective upturned distal tips or ends 1196 and 1197. The upturned tips or ends 1196 and 1197 facilitate proper installation of the clip 1154 onto the clamp body 1024, allowing the flange 1192 to more easily slide up onto the top surface 1060 of the clamp body 1024. When the clip 1154 is installed, the threaded rod 1022 is engaged by a curved inner edge 1198 of the U-shaped notch 1193.

The gripping legs 1162 and 1164 secure the clip 1154 to the clamp body 1024. The top flange 1192 secures the fastener 1036 within the clamp body recess 1065 when the clip 1154 is secured to the clamp body 1024. The inner edge 1198 of the top flange notch 1193 aids in securing the threaded rod 1022, preventing the threaded rod 1022 from wobbling. The extension 1186 also aids in securing the threaded rod 1022, with the tab 1190 pressing against the threaded rod 1022. At the top of the clamp 1020, the threaded rod 1022 is secured between the upper cylindrical surface 1150 and the notch inner edge 1198. At the bottom of the clamp 1020, the threaded rod 1022 is secured between the lower cylindrical surface 1152 and the tab 1190 of the extension 1186.

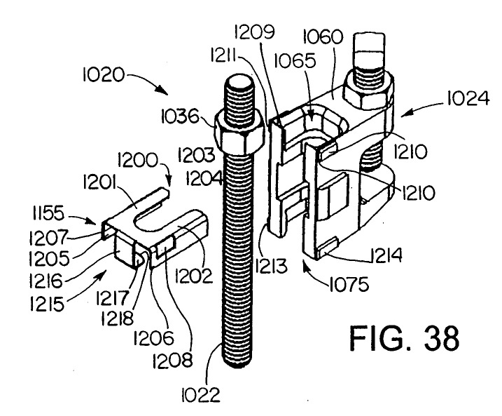

FIGS. 36-38 show a variant of the clamp 1020, with a clip 1155 used to secure the threaded rod 1022 and the fastener 1036. The clip 1155 includes a top flange 1200 for securing the fastener 1036 within the recess 1065 in the clamp body 1024. The top flange 1200 includes flange legs 1201 and 1202 on either side of a U-shape notch 1203. When the clip 1155 is installed on the top surface 1060 of the clamp body 1024, the threaded rod 1022 is received in the notch 1203, with a curved inner edge 1204 of the notch 1203 engaging the threaded rod 1022 to help secure the threaded rod 1022 in place.

Side flanges 1205 and 1206 are bent downward from the respective sides of the top flange 1200. The side flanges 1205 and 1206 have respective windows 1207 and 1208. The windows 1207 and 1208 are configured for receiving and securing therein top protrusions 1209 and 1210 on opposite sides of the clamp body 1024. The protrusions 1209 and 1210 may be secured within the windows 1207 and 1208 in a manner similar to that of other embodiments described herein. The top protrusions 1209 and 1210 have respected chamfered back edges 1211 and 1212. The chamfered back edges 1211 and 1212 aid in urging the side flanges 1205 and 1206 resiliently outward as the clip 1155 is installed onto the clamp body 1024.

The clamp body 1024 may have bottom protrusions 1213 and 1214 that may be substantially identical in placement and configuration to the top protrusions 1209 and 1210. The bottom protrusions 1213 and 1214 allow the clip 1155 to alternatively be used to secure the fastener 1036 within the bottom recess 1075. As another alternative, a pair of clips 1155 may be secured to both sets of the protrusions 1209/1210 and 1213/1214, to provide additional support for the threaded rod 1022.

A rod-engaging extension 1215 extends downward and inward from a back end of the top flange 1200. The extension 1215 includes a downward-bent leg 1216 extending from the top flange 1200, and an inward-bent tab 1217 extending from the leg 1216. A distal edge 1218 of the tab 1217 engages the threaded rod 1022, to aid in holding the threaded rod 1022 in place.

It will be appreciated that many alternatives and combinations may be made using various suitable features of the various embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A structural clamp comprising:
a clamp body having a main body portion, and top and bottom flanges protruding from the main body portion;
wherein the clamp body has a hollow portion running therethrough, accessible through an open slot in the clamp body.

2. The clamp of claim 1, wherein the clamp body has one or more protrusions on a top surface.

3. The clamp of claim 2,
in combination with a threaded rod in the hollow portion, and a threaded fastener on the threaded rod;
wherein the one or more protrusions are configured to prevent rotation of the threaded fastener when the threaded fastener is against the top surface.

4. The clamp of claim 3, wherein the one or more protrusions include a pair of triangular protrusions configured to bear against adjacent faces of a square nut.

5. The clamp of claim 3, wherein the one or more protrusions include a pair of protrusions configured to bear against diametrically opposed faces of the threaded fastener.

6. The clamp of claim 3,
wherein the fastener is a hex nut; and
wherein the one or more protrusions include protrusions configured to bear against faces of the hex nut.

7. The clamp of claim 6, wherein the protrusions are configured to bear against at least four of the faces of the hex nut.

8. The clamp of claim 1, further comprising a clip that is coupled to the clamp body, preventing egress from the central hollow through the open slot.

9. The clamp of claim 9, wherein the clip has gripping portions that engage sides of the clamp body.

10. The clamp of claim 10, wherein the gripping portions have windows therein that receive protrusions on the sides of the clamp body.

11. The clamp of claim 8, wherein the clip has inner legs that protrude through the open slot when the clip is coupled to the clamp body.

12. The clamp of claim 8,
wherein the clamp body has a recess on a top surface; and
wherein the clip covers the recess.

13. The clamp of claim 8, wherein the clip is a spring steel clip.

14. The clamp of claim 1, wherein the clamp body is a cast clamp body.

15. The clamp of claim 1, wherein the cast clamp body is cast ductile iron.

16. A structural clamp comprising:
a cast clamp body having a main body portion, and top and bottom flanges protruding from the main body portion;
wherein the clamp body has a hollow portion running therethrough.

17. The clamp of claim 16, wherein the cast clamp body is made of cast iron.

18. The clamp of claim 17, wherein the cast clamp body is electro zinc plated.

19. The clamp of claim 16, wherein the hollow portion is a through hole that is threaded at one end.
